(19) United States
(12) Patent Application Publication
(10) Pub. No.: US 2017/0346888 A1
(43) Pub. Date: Nov. 30, 2017

(54) OVERLAY MANAGEMENT SERVER AND RESOURCE ALLOCATION METHOD THEREOF

(71) Applicant: Electronics and Telecommunications Research Institute, Daejeon (KR)

(72) Inventors: Sung Hei KIM, Daejeon (KR); Changkyu LEE, Daejeon (KR); Wook HYUN, Daejeon (KR)

(73) Assignee: Electronics and Telecommunications Research Institute, Daejeon (KR)

(21) Appl. No.: 15/596,247

(22) Filed: May 16, 2017

(30) Foreign Application Priority Data
May 27, 2016 (KR) 10-2016-0065255
Mar. 28, 2017 (KR) 10-2017-0038997

(51) Int. Cl. H04L 29/08; H04L 29/06

(52) U.S. Cl. CPC H04L 67/107; H04L 67/1078; H04L 65/4069

(57) ABSTRACT

A resource allocation method of an overlay management server (OMS) is disclosed. The resource allocation method may include transmitting, to a cache server (CS), a remote peer list determined based on a network distance between each of peers and the CS, receiving, from the CS, a peer list including an identifier of a peer receiving contents from the CS in response to the identifier of the peer being included in the remote peer list, and selecting another CS for the peer in response to the peer list being received.

### CROSS-REFERENCE TO RELATED APPLICATIONS

This application claims the priority benefit of Korean Patent Application No. 10-2016-0065255 filed on May 27, 2016, and Korean Patent Application No. 10-2017-0038997 filed on Mar. 28, 2017, in the Korean Intellectual Property Office, the disclosures of which are incorporated herein by reference for all purposes.

### BACKGROUND

### 1. Field

One or more example embodiments relate to an overlay management server (OMS) and a resource allocation method of the OMS.

### 2. Description of Related Art

A peer-to-peer (P2P) network refers to a distributed network in which peers are directly connected, and a peer transmits and receives contents to and from another peer that is not a server. Thus, a peer may be a client that receives contents, and also a server that provides contents. In addition, the P2P network may be established based on contents to be shared, not a specific server. Thus, in the P2P network, a peer connection and a network size may be flexible.

For example, as existing technology related to the P2P network, Korean Patent Publication No. 10-2014-0008065 entitled “Peer-to-Peer Network System with Manageability” discloses a P2P network system that may provide at least one peer with information needed to configure a P2P network using at least one of information associated with a status of the at least one peer, information associated with a status of an underlying network, or information associated with a user in a service side, allow a service provider to stably provide a service to the at least one peer, and have a management function to control the provided service.

Using such a P2P network, a streaming service may be provided. Concisely, a P2P-based streaming service may be provided. Here, in a case that a contents provider does not request the use of an idle resource despite the presence of such an idle resource in the P2P network, peers may be connected only to the contents provider. In such a case, the contents provider may not readily distribute contents to the peers.

### SUMMARY

According to an aspect, there is provided a resource allocation method of an overlay management server (OMS), the resource allocation method including transmitting, to a cache server (CS), a remote peer list determined based on a network distance between each of peers in an overlay network and the CS, receiving, from the CS, a peer list including an identifier of a peer interacting with the CS in response to the remote peer list being transmitted, and selecting another CS to be added to the overlay network using the peer list.

The selecting of the another CS may include obtaining a CS list determined based on a network distance between each of CSs and the peer in response to the peer list being received, and selecting the another CS among the CSs based on the CS list.

The resource allocation method may further include receiving resource utilization status information from the CS, and determining whether to release a resource of the CS based on the resource utilization status information.

The resource utilization status information may include a start timestamp indicating a start time of a check of a resource utilization status of the CS, an end timestamp indicating an end time of the check of the resource utilization status of the CS, a storage usage of the CS, an upload traffic of the CS, a download traffic of the CS, an uplink bandwidth of the CS, a downlink bandwidth of the CS, a number of peer connections used for the CS to upload traffic, and a number of peer connections used for the CS to download traffic.

The resource allocation method may further include transmitting a request message to the another CS to reserve a resource of the another CS, and receiving a response message from the another CS.

The response message may include an identifier of the resource to be reserved, an identifier of a virtual peer of the another CS, or a maximum allocation time of the resource.

The CS may verify whether the peer is included in the remote peer list in response to the remote peer list being received, and add the peer to the peer list to be transmitted to the OMS in response to the peer being included in the remote peer list.

According to another aspect, there is provided an OMS including a communication interface, and a controller configured to transmit, to a CS through the communication interface, a remote peer list determined based on a network distance between each of peers in an overlay network and the CS, receive a peer list including an identifier of a peer interacting with the CS from the CS through the communication interface in response to the remote peer list being transmitted, and select another CS to be added to the overlay network using the peer list.

The controller may obtain a CS list determined based on a network distance between each of CSs and the peer, and select the another CS among the CSs based on the CS list.

The controller may receive resource utilization status information from the CS through the communication interface, and determine whether to release a resource of the CS based on the resource utilization status information.

The resource utilization status information may include a start timestamp indicating a start time of a check of a resource utilization status of the CS, an end timestamp indicating an end time of the check of the resource utilization status of the CS, a storage usage of the CS, an upload traffic of the CS, a download traffic of the CS, an uplink bandwidth of the CS, a downlink bandwidth of the CS, a number of peer connections used for the CS to upload traffic, and a number of peer connections used for the CS to download traffic.

The controller may transmit a request message to the another CS through the communication interface to reserve a resource of the another CS, and receive a response message from the another CS through the communication interface.

The response message may include at least one of an identifier of the resource to be reserved, an identifier of a virtual peer of the another CS, or a maximum allocation time of the resource.

The CS may verify whether the peer is included in the remote peer list in response to the remote peer list being received, and add the peer to the peer list to be transmitted to the OMS in response to the peer being included in the remote peer list.

According to still another aspect, there is provided a managed peer-to-peer (MP2P) network system including a CS, and an OMS configured to transmit, to the CS, a remote peer list determined based on a network distance between each of peers and the CS, receive, from the CS, a peer list including an identifier of a peer interacting with the CS in response to the remote peer list being transmitted, and select another CS to be added to an overlay network using the peer list.

The OMS may receive a CS list determined based on a network distance between each of CSs and the peer in response to the peer list being received, and select the another CS among the CSs based on the CS list.

The OMS may receive resource utilization status information from the CS, and determine whether to release a resource of the CS based on the resource utilization status information.

The resource utilization status information may include a start timestamp indicating a start time of a check of a resource utilization status of the CS, an end timestamp indicating an end time of the check of the resource utilization status of the CS, a storage usage of the CS, an upload traffic of the CS, a download traffic of the CS, an uplink bandwidth of the CS, a downlink bandwidth of the CS, a number of peer connections used for the CS to upload traffic, and a number of peer connections used for the CS to download traffic.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a managed peer-to-peer (MP2P) network system according to an example embodiment;

FIG. 2 is a diagram illustrating an example of a flow of operations performed in an MP2P network system in which a cache server (CS) reports a list of remote peers among peers served by the CS according to an example embodiment;

FIG. 3 is a diagram illustrating an example of a flow of operations performed in an MP2P network system in which an overlay management server (OMS) selects a CS according to an example embodiment;

FIG. 4 is a diagram illustrating an example of a flow of operations performed in an MP2P network system in which a CS reports a resource utilization status according to an example embodiment;

FIG. 5 is a flowchart illustrating an example of a resource allocation method of an OMS in an MP2P network system according to an example embodiment; and

FIG. 6 is a diagram illustrating an example of an OMS in an MP2P network system according to an example embodiment.

### DETAILED DESCRIPTION

Hereinafter, some example embodiments will be described in detail with reference to the accompanying drawings.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof. Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Terms used herein will be briefly described as follows before the description of example embodiments.

An overlay management server (OMS) may manage a managed peer-to-peer (MP2P) network, and aid peers participating in the MP2P network. Through an interaction with an underlying network information server (UNIS), the OMS may provide an optimal peer list to establish an optimal MP2P network.

The UNIS refers to a server configured to provide information associated with a network distance between peers in the MP2P network. The UNIS may interact with the peers and the OMS.

An overlay network refers to a virtual network that is run on another network. The overlay network may include a set of nodes and links among the nodes. Such links are logical, and thus may correspond to physical links of an underlying network.

A cache server (CS) refers to a dedicated server configured to cache entire contents or a portion of the contents to achieve a certain purpose in the MP2P network. The CS may have at least one virtual peer.

An overlay resource refers to a dedicated resource for the overlay network to improve stability and performance of the overlay network. The overlay resource may include at least one virtual peer of the CS and at least one relay instance of a relay server (RS).

The relay instance refers to an instance that relays traffic. The relay instance may perform a traffic relay for a specific peer behind a network address translation (NAT)/firewall (FW). All relay instances operating in the RS may be identified. Concisely, a unique identifier may be allocated to each of the relay instances.

The RS refers to a dedicated server configured to relay traffic to at least one peer behind the NAT/FW in the MP2P network, or receive traffic relayed from the at least one peer behind the NAT/FW. The RS may have at least one relay instance.

The virtual peer refers to an instance operating as a peer that is run in the CS. The virtual peer operating as the peer may participate in at least one overlay network, and exchange a fragment with other peers. Here, the fragment refers to a portion of contents. The virtual peer operating in the CS may be identified. Concisely, a unique identifier may be allocated to the virtual peer.

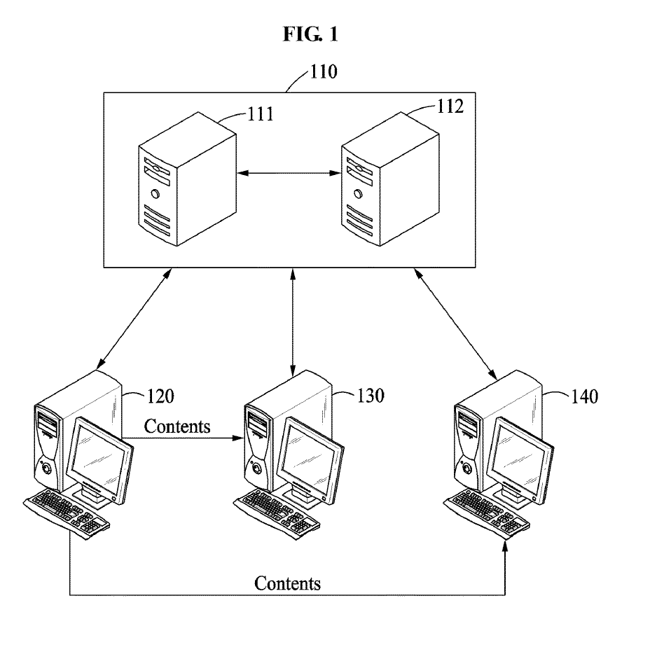

FIG. 1 is a diagram illustrating an example of an MP2P network system according to an example embodiment.

Referring to FIG. 1, an MP2P network system includes a server 110 and a plurality of peers, for example, a peer 120, a peer 130, and a peer 140.

The server 110 includes a peer activity management server (PAMS) 111 and an OMS 112.

The PAMS 111 and the OMS 112 may be physically distinguished from each other. Based on an example embodiment, the PAMS 111 and the OMS 112 may be logically distinguished from each other in a single server, for example, the server 110.

Although not illustrated in FIG. 1, the MP2P network system may further include at least one of a CS, an RS, or an UNIS.

The PAMS 111 may manage information of each of the peers 120, 130, and 140. For example, the PAMS 111 may collect or manage status information of each of the peers 120, 130, and 140. In one example, the status information may include static information. Table 1 below illustrates examples of the static information.

TABLE 1

| Infor- | | |
|---|---|---|
| mation | | |
| type | Information | Meaning |
| Static | Maximum download BW | Maximum download bandwidth |
| Static | Maximum download BW | Maximum download bandwidth |
| | per overlay network | of a peer per overlay network |
| | (BWₘₐₓ) | |
| Static | Maximum upload BW | Maximum upload bandwidth |
| Static | Maximum upload BW | Maximum upload bandwidth |
| | per overlay network | per overlay network |
| Static | Maximum number of | Maximum number of connections |
| | connections for upload | of a peer per overlay network |
| | per overlay network | |
| | (CONNECTIONₘₐₓ) | |

The status information may also include dynamic information. The dynamic information may be associated with an activity of each of the peers 120, 130, and 140. The peers 120 through 140 may report the dynamic information to the PAMS 111 in each report period. Table 2 below illustrates examples of the dynamic information.

TABLE 2

| Infor- | | |
|---|---|---|
| mation | | |
| type | Information | Meaning |
| Dynamic | OVERLAY_ID | Identification (ID) of an overlay |
| | | network in which a peer participates |
| Dynamic | OverlayEvent | Indicating a status of participation |
| | | in an overlay network, the status |
| | | may be set to be “COMPLETED” |
| | | when a peer receives entire contents, |
| | | and the status may be set to be |
| | | “STOPPED” when the peer |
| | | stops exchanging data with another |
| | | peer and “STARTED” for a |
| | | status other than the status set |
| | | as “COMPLETED” and the |
| | | status set as “STOPPED” |
| Dynamic | Downloaded | Total amount (kilobyte (KB) as |
| | | a unit) downloaded after a peer |
| | | reports previous dynamic information |
| Dynamic | Uploaded | Total amount (KB as a unit) |
| | | uploaded after a peer reports |
| | | previous dynamic information |
| Dynamic | Left | Amount (KB as a unit) to be |
| | | additionally downloaded to |
| | | complete downloading |
| Dynamic | Connections_for_up | Number of connections maintained |
| | | for current uploading |
| Dynamic | Connections_for_dn | Number of connections maintained |
| | | for current downloading |

In one example, under the assumption that the peer 120 currently operates as a contents provider, that is, the peer 120 distributes contents to the peer 130 and the peer 140, and the peer 120 does not have a sufficient resource, the peer 120 may not readily distribute the contents to the peer 130 and the peer 140. In such an example, the OMS 112 may verify a load status of the peer 120, or the contents provider, and a contents reception status of each of the peer 130 and the peer 140, and determine whether to allocate a CS. Hereinafter, how the OMS 112 verifies the load status of the peer 120 and the contents reception status of each of the peer 130 and the peer 140 will be described.

The OMS 112 may verify the load status of the peer 120, or the contents provider, as follows.

The OMS 112 may receive status information of the peer 120 from the PAMS 111, and verify the load status of the peer 120 based on the status information of the peer 120. For example, in a case that uploaded information of dynamic information of the peer 120 is close to BWₘₐₓ information of static information of the peer 120, that is, such information becomes within a bandwidth threshold, or BW_{THRESHOLD}, the OMS 112 may determine that an overload occurs in the peer 120. For another example, in a case that Connections_for_up information of the dynamic information of the peer 120 is close to CONNECTIONₘₐₓ information of the static information of the peer 120, that is, such information becomes within a threshold connection number, or CONNECTION_{THRESHOLD}, the OMS 112 may determine that an overload occurs in the peer 120.

In addition, the OMS 112 may verify the contents reception status of each of the peer 130 and the peer 140 as follows.

The OMS 112 may receive status information of each of the peer 130 and the peer 140 from the PAMS 111, and verify the contents reception status of each of the peer 130 and the peer 140 based on the status information of each of the peer 130 and the peer 140. For example, the OMS 112 may calculate a current download speed of each of the peer 130 and the peer 140 based on Equation 1 below.

$${D}_{CUR} = \frac{{DIFF}_{DOWNLOADED}}{PERIOD} \qquad [ Equation 1 ]$$

In Equation 1, D_{CUR} denotes the current download speed of each of the peer 130 and the peer 140. DIFF_{DOWNLOADED} denotes a difference between Downloaded information of dynamic information reported at a point t and Downloaded information of dynamic information reported at a point (t−1), which is represented by Equation 2 below. In addition, PERIOD denotes a report period of dynamic information.

DIFF_{DOWNLOADED}=DOWNLOADEDₜ−DOWNLOADEDₜ₋₁ [Equation 2]

When calculating D_{CUR} of each of the peer 130 and the peer 140, the OMS 112 may verify the contents reception status of each of the peer 130 and the peer 140 based on a result of comparing a maximum download speed D_{MAX} and the calculated D_{CUR} of each of the peer 130 and the peer 140. Here, when a difference between the D_{MAX} and the D_{CUR} of the peer 130 is greater than a difference threshold D_{THRESHOLD}, the OMS 112 may determine that the contents reception status of the peer 130 is not desirable. Similarly, when a difference between the D_{MAX} and the D_{CUR} of the peer 140 is greater than the D_{THRESHOLD}, the OMS 112 may determine that the contents reception status of the peer 140 is not desirable.

For another example, when a difference between Fᵣₐₜₑ, which corresponds to a speed or rate at which the peer 120, the contents provider, generates contents, and the D_{CUR} of each of the peer 130 and the peer 140 is greater than or equal to a threshold, the OMS 112 may determine that the contents reception status of each of the peer 130 and the peer 140 is not desirable.

The OMS 112 may determine whether to allocate a CS based on the load status of the peer 120, which is the contents provider, and on the contents reception status of each of the peer 130 and the peer 140, which are contents receivers.

Based on an example embodiment, the OMS 112 may determine whether to allocate a CS based solely on the load status of the peer 120, which is the contents provider, or based solely on the contents reception status of each of the peer 130 and the peer 140, which are the contents receivers.

In response to a determination that a load occurs in the peer 120 and the contents reception status of each of the peer 130 and the peer 140 is not desirable, the OMS 112 may determine an allocation of a CS. In a case that at least two idle CSs are present in an overlay network, the OMS 112 may select at least one CS based on one of the following standards, and allocate the selected CS.

First Standard: Allocate a CS that is Closest in a Network Distance from a Contents Provider, for Example, the Peer 120

In a case that a number of allocated CSs in the overlay network is small, and the load status of the peer 120, the contents provider, is verified, the OMS 112 may allocate a CS based on the first standard. Here, when a difference between “Connections_for_up” of the dynamic information of the peer 120 and the number of the CSs already allocated to the overlay network is greater than or equal to a preset reference value, the OMS 112 may determine that the number of the allocated CSs is small.

For example, when it is determined that the number of the allocated CSs in the overlay network is small and an overload occurs in the peer 120, the OMS 112 may provide information associated with the peer 120 and a CS list to an UNIS. The UNIS may arrange the CS list in order of the CSs based on a network distance between each of the CSs and the peer 120. Here, the CS list may be arranged in order starting from a CS having a closest network distance from the peer 120, or arranged in order starting from a CS having a farthest network distance from the peer 120. The UNIS may provide the arranged CS list, or the ordered CS list hereinafter, to the OMS 112. The OMS 112 may select a CS having an available resource from the ordered CS list, and allocate the selected CS.

Second Standard: Allocate a CS Located in an Area in which Peers not Receiving Contents Properly are Present

In a case that the number of the allocated CSs in the overlay network is large, and peers, for example, the peer 130 and the peer 140, in a certain area do not receive contents properly, the OMS 112 may allocate a CS based on the second standard. For example, the OMS 112 may provide the UNIS with information associated with the peer 130 and the peer 140 in the area and a CS list. The UNIS may arrange the CS list in order based on a network distance between each of the CSs and each of the peer 130 and the peer 140. The UNIS may provide the ordered CS list to the OMS 112. The OMS 112 may select a CS having an available resource from the ordered CS list, and allocate the selected CS.

In place of the peer 120, the CS may distribute contents to the peer 130 and the peer 140, and thus an effective contents distribution may be enabled.

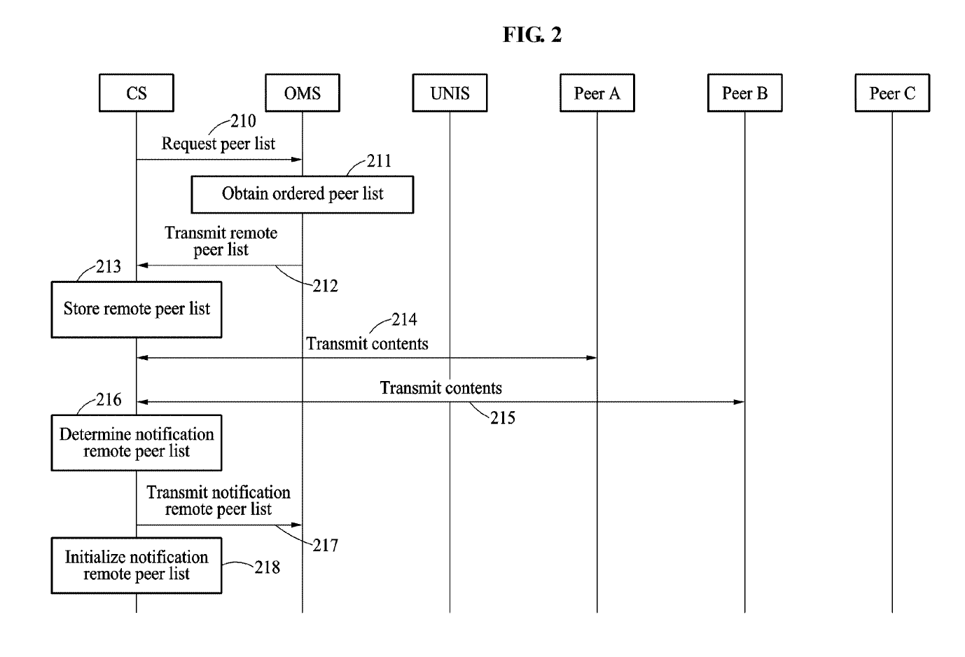

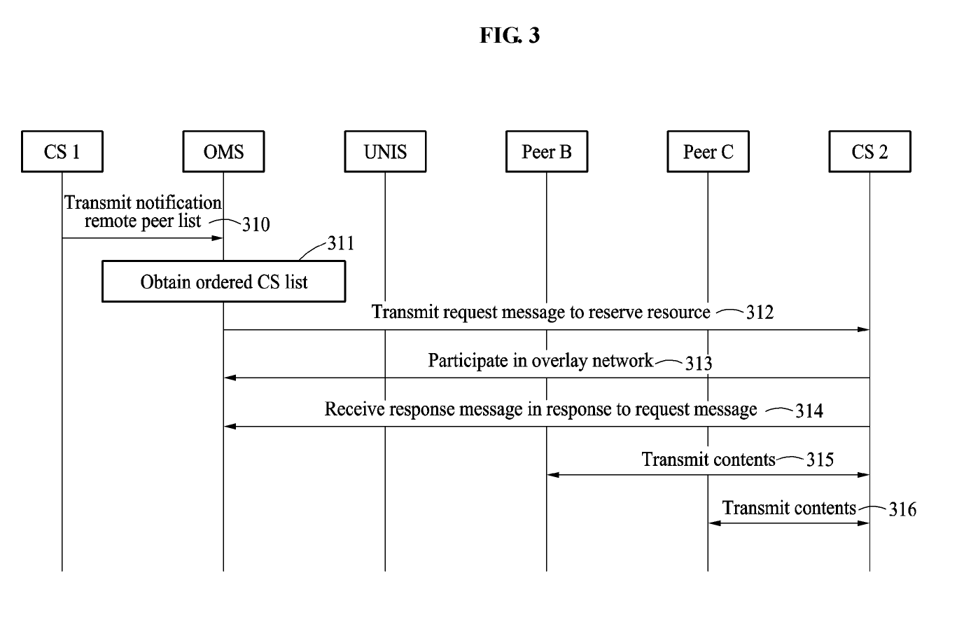

However, in a case of a remote peer, which is separated remotely from the CS, the remote peer may not readily receive contents from the CS. In such a case, the OMS 112 may allocate another CS. Hereinafter, the allocating of the another CS will be described in detail with reference to FIGS. 2 and 3.

FIG. 2 is a diagram illustrating an example of a flow of operations performed in an MP2P network system in which a CS reports a list of remote peers among peers served by the CS according to an example embodiment.

Referring to FIG. 2, in operation 210, a CS requests a peer list from an OMS.

In operation 211, the OMS obtains an ordered peer list. The ordered peer list refers to a peer list arranged in order based on a network distance between the CS and each of peers. For example, as illustrated in FIG. 2, in a case that a peer A is closest to the CS and a peer C is farthest from the CS among peers A, B, and C, the peer list may be arranged in order starting from the peer C to the peer B and the peer A sequentially, and the OMS may obtain the ordered peer list arranged in order of the peer C, the peer B, and the peer A. Based on an example embodiment, the OMS may obtain the peer list arranged in order of the peer A, the peer B, and the peer C.

In one example, the OMS may obtain the ordered peer list by interfacing with a UNIS. That is, the OMS may interface with the UNIS to obtain the ordered peer list.

In operation 212, the OMS transmits a remote peer list to the CS. In one example, when the OMS obtains the ordered peer list, the OMS may determine the remote peer list by comparing, to a threshold distance, the network distance between each of the peers and the CS. In the example illustrated in FIG. 2, in a case that a network distance between the peer A and the CS is less than the threshold distance, and each of a network distance between the peer B and the CS and a network distance between the peer C and the CS is greater than or equal to the threshold distance, the OMS may determine the remote peer list including an identifier of each of the peer B and the peer C, and transmit the remote peer list to the CS. That is, the OMS may transmit the remote peer list, for example, “(remote) peer list={peer B, peer C},” to the CS.

In operation 213, the CS stores the remote peer list. When the CS receives the remote peer list, the CS may verify at least one peer that is remote from the CS. In the example illustrated in FIG. 2, when the CS receives “(remote) peer list={peer B, peer C}” from the OMS, the CS may verify that the peer B and the peer C are remote from the CS.

The CS transmits contents to the peer A in operation 214, and to the peer B in operation 215. That is, the CS may currently serve the peer A and the peer B, or provide a service to the peer A and the peer B.

In operation 216, the CS determines a notification remote peer list. The notification remote peer list refers herein to a peer list to be notified to the OMS by the CS. In one example, the CS may verify whether a peer currently served by the CS is included in the remote peer list, and add the peer to the peer list to be notified to the OMS, for example, the notification remote peer list, in response to the peer served by the CS being included in the remote peer list. In the example illustrated in FIG. 2, in a case that the CS currently serves the peer A and the peer B, and the peer B among the peers currently served by the CS is included in the remote peer list, the CS may add the peer B to the peer list to be notified to the OMS, for example, the notification remote peer list. Thus, the CS may determine, for example, “(notification remote) peer list={peer B}.”

In operation 217, the CS transmits the notification remote peer list to the OMS. The CS may report, to the OMS, the peer list including an identifier of a remote peer among peers served by the CS. That is, the CS may transmit, to the OMS, information associated with the remote peer among the peers served by the CS. In the example illustrated in FIG. 2, the CS may transmit, to the OMS, “(notification remote) peer list={peer B}.” Thus, the OMS may be notified that the CS is transmitting contents to a peer that is currently remote from the CS, for example, a remote peer.

In operation 218, the CS initializes the notification remote peer list.

When the OMS receives the notification remote peer list from the CS, the OMS may be notified that the CS is transmitting the contents to the remote peer. The remote peer is remote from the CS, and thus may not readily receive the contents. In such a case, the OMS may select at least one other CS for the remote peer, and allocate the selected CS to the remote peer. Hereinafter, how the OMS selects another CS will be described in detail with reference to FIG. 3.

FIG. 3 is a diagram illustrating an example of a flow of operations performed in an MP2P network system in which an OMS selects a CS according to an example embodiment.

Referring to FIG. 3, in operation 310, CS1 transmits a notification remote peer list to an OMS. In the example illustrated in FIG. 3, CS1 transmits, for example, “(notification remote) peer list={peer B, peer C}.” That is, CS1 may notify the OMS that a peer B and a peer C being at a distance or remote location receive a service.

The OMS may interact with a UNIS to discover a suitable CS to serve both the peer B and the peer C. In operation 311, the OMS obtains an ordered CS list. The ordered CS list refers to a CS list arranged in order based on a network distance between each of CSs excluding CS1 and each of at least one peer included in the notification remote peer list. In the example illustrated in FIG. 3, the OMS may interwork with the UNIS to arrange the CS list in order based on the network distance between each of the peer B and the peer C and each of the CSs excluding CS1. The OMS may select at least one CS by referring to the ordered CS list. Here, in a case that a CS may not support the peer B or the peer C, although the CS is closest to the peer B or the peer C, the CS may be excluded from a selection of the at least one CS. The OMS may discover at least one suitable CS based on a distance standard and a resource status, for example, resource utilization status information to be described later. For example, when CS2 and CS3 satisfy the distance standard, for example, when CS2 and CS3 are close, in a network distance, to both the peer B and the peer C, and it is determined that CS3 is not available based on the resource utilization status information, the OMS may not select CS3.

In the example illustrated in FIG. 3, the OMS selects CS2.

In operation 312, the OMS transmits a request message to CS2 to reserve a resource.

CS2 participates in an overlay network in operation 313, and transmits a response message to the OMS in response to the request message in operation 314. The response message may include at least one of an identifier of a resource to be reserved, an identifier of a virtual peer of the selected CS, or a maximum allocation time of the resource to be reserved. For example, the response message may include “vp_abcd1235” as an identifier of a virtual peer of CS2 and “1024 minutes” as the maximum allocation time.

CS2 transmits contents to the peer B in operation 315, and to the peer C in operation 316. By transmitting the contents to each of the peer B and the peer C by CS2, which is most suitable for the peer B and the peer C, in place of CS1, an effective contents distribution may be enabled. Concisely, an effective streaming service may be enabled.

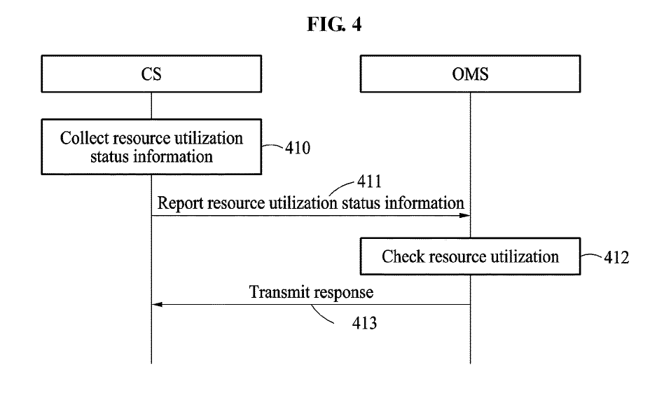

FIG. 4 is a diagram illustrating an example of a flow of operations performed in an MP2P network system in which a CS reports a resource utilization status according to an example embodiment.

Referring to FIG. 4, in operation 410, a CS collects resource utilization status information. In operation 411, the CS reports the resource utilization status information to an OMS. That is, the CS may transmit, to the OMS, the resource utilization status information using, for example, an ORCP_USAGE_REPORT message.

The resource utilization status information may include one of, for example, a start timestamp indicating a start time of a check of a resource utilization status of the CS, an end timestamp indicating an end time of the check of the resource utilization status of the CS, a storage usage of the CS, an upload traffic of the CS, a download traffic of the CS, an uplink bandwidth of the CS, a downlink bandwidth of the CS, a number of peer connections used for the CS to upload traffic, and a number of peer connections used for the CS to download traffic, or a combination thereof.

In operation 412, the OMS checks or verifies resource utilization of the CS based on the resource utilization status information. That is, the OMS may determine whether to release or allocate an overlay resource by analyzing the resource utilization status information. When the OMS determines an allocation of the overlay resource, or a new virtual peer, the OMS may consider such elements as a network distance from peers and a network distance from a source peer to select a suitable CS. Here, the source peer refers to a contents provider, which is described with reference to FIG. 1.

The OMS may be notified of a more accurate resource utilization status of the CS or a more accurate resource usage status by receiving a report on the resource utilization status information from the CS.

In one example, the OMS may determine whether the CS remains idle based on the resource utilization status information of the CS. For example, the OMS may determine whether the CS, which is described with reference to FIG. 2, remains idle based on resource utilization status information of the CS. In addition, the OMS may determine whether CS2, which is described with reference to FIG. 3, remains idle based on resource utilization status information of CS2.

In response to a determination that the CS is idle, the OMS may release or return a resource of the CS, thereby improving further resource utilization.

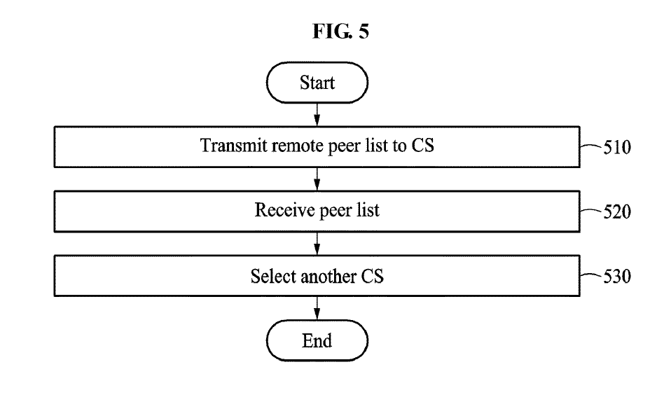

FIG. 5 is a flowchart illustrating an example of a resource allocation method of an OMS in an MP2P network system according to an example embodiment.

Referring to FIG. 5, in operation 510, an OMS transmits a remote peer list to a CS. The remote peer list may be determined based on a network distance between each of peers and the CS.

In operation 520, when the remote peer list is transmitted, the OMS receives, from the CS, a peer list including an identifier of a peer interacting with the CS. For example, when an identifier of a peer receiving contents from the CS is included in the remote peer list, the OMS may receive the peer list including the identifier of the peer from the CS. That is, the CS may notify the OMS of a peer being included both among peers in the remote peer list and among peers receiving the contents.

In operation 530, the OMS selects another CS to be added to an overlay network using the peer list. For example, in a case that the OMS receives “(notification remote) peer list={peer B, peer C}” from the CS, the OMS may interact with an UNIS to discover a most suitable CS that serves both the peer B and the peer C. That is, the OMS may arrange, in order, a CS list based on a network distance between each of CSs and the peer B and a network distance between each of the CSs and the peer C by interacting with the UNIS, and select the most suitable CS that serves both the peer B and the peer C from the ordered CS list.

The descriptions provided with reference to FIGS. 1 through 4 may be applicable to the operations described with reference to FIG. 5, and thus a more detailed description will be omitted here for brevity.

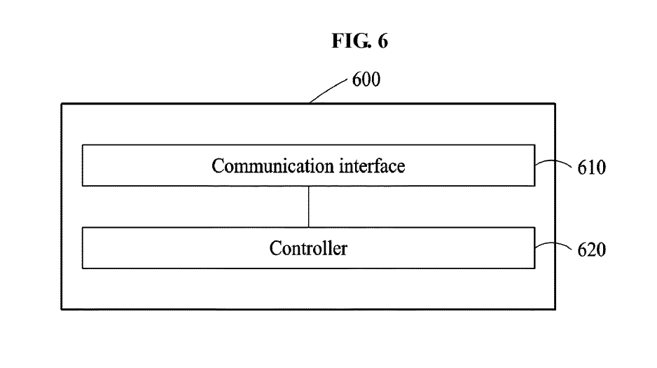

FIG. 6 is a diagram illustrating an example of an OMS in an MP2P network system according to an example embodiment.

Referring to FIG. 6, an OMS 600 includes a communication interface 610 and a controller 620.

The controller 620 may transmit, to a CS through the communication interface 610, a remote peer list determined based on a network distance between each of peers and the CS.

In response to the remote peer list being transmitted, the controller 620 may receive, from the CS through the communication interface 610, a peer list including an identifier of a peer interacting with the CS.

The controller 620 may select another CS to be added to an overlay network using the peer list.

The descriptions provided with reference to FIGS. 1 through 4 may be applicable to the OMS 600 described with reference to FIG. 6, and thus a more detailed description will be omitted here for brevity.

According to example embodiments described herein, in a case that a peer does not readily receive contents, by determining status information of a peer and status information of a CS, an allocation of a suitable CS may be enabled.

According to example embodiments described herein, by allocating a suitable CS based on a network distance from at least one peer receiving contents, an effective distribution of streaming contents may be enabled. In addition, in a case that an accurate number of required CSs is not recognized due to peers dynamically entering or leaving an overlay network, by allocating a suitable number of CSs, the effective distribution of streaming contents may be enabled.

According to example embodiments, in a case that an allocated CS is no longer used, releasing the allocated CS may be enabled.

The descriptions provided with reference to FIGS. 1 through 4 may be applicable to the operations described with reference to FIG. 6, and thus a more detailed description will be omitted here for brevity.

In an embodiment, when the OMS decides on the allocation and retrieval of the overlay resource of a CS/RS for a specific overlay network, it needs to know the resource utilization status of the CS/RS. The CS/RS gathers its overlay resource utilization status, and sends it to the OMS. The OMS decides on allocating or releasing overlay resource by analyzing the status information gathered from the CS/RS. It is also possible to make use of other information by interacting with the PAMS. When it decides to allocate a new virtual peer, the OMS can consider several factors, such as network distance from the source peer, network distance from peers in need, on choosing an appropriate CS/RS. These procedures are repeated periodically.

In an embodiment, in order to realize the contents distribution structure for live streaming, the OMS needs to make a decision about allocating CS(s) in appropriate location(s) for peers to retrieve contents from a close CS from the network perspective. The CS and OMS can share information about the peers served by virtual peers running on the CS. The OMS can provide the CS with information about the peers distant from the CS. The CS can periodically provide a list of peers from distant locations that it has serviced. This information can be used by the OMS in allocating the appropriate CS to be used in the overlay network for live streaming.

The CS can periodically report these lists to the OMS. After every reporting period timeout, the CS sends the list of peers in distant locations that it has serviced. The CS also requests the new list of peers from the OMS. The OMS checks if there are changes in the peers in the overlay network. The OMS interfaces with the UNIS the get the ordered peer list with regards to the network distance from the CS. For example, peer B and peer C are calculated to be distant from CS. The OMS responds to the CS with peer B and peer C. The CS stores this information. As peers interface with the CS, the CS checks if the peer that it had serviced is part of the received peer list. For example, the CS interacts with peer B and peer C, and each of peer B and C is a peer in distant locations. The CS adds them to the peer list that will be notified to the OMS. The OMS selects a new CS to be added to the overlay network by using the information from the peer list in the report from the CS. The CS informs the OMS that peer B and peer C are the peers from distant locations that it has serviced. The OMS interacts with the UNIS to find an adequate CS that is appropriate in servicing both peer B and peer C. The OMS selects CS2 and reserves the CS2 to be used in the overlay network.

The components described in example embodiments of the present disclosure may be achieved by hardware components including at least one digital signal processor (DSP), a processor, a controller, an application specific integrated circuit (ASIC), a programmable logic element such as a field programmable gate array (FPGA), other electronic devices, and combinations thereof. At least some of the functions or the processes described in the example embodiments of the present disclosure may be achieved by software, and the software may be recorded on a recording medium. The components, the functions, and the processes described in the example embodiments of the present disclosure may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A resource allocation method of an overlay management server (OMS), the resource allocation method comprising:
transmitting, to a cache server (CS), a remote peer list determined based on a network distance between each of peers in an overlay network and the CS;
in response to the remote peer list being transmitted, receiving, from the CS, a peer list including an identifier of a peer interacting with the CS; and
selecting another CS to be added to the overlay network using the peer list.

2. The resource allocation method of claim 1, wherein the selecting of the another CS comprises:
obtaining a CS list determined based on a network distance between each of CSs and the peer; and
selecting the another CS from the CS list.

3. The resource allocation method of claim 1, further comprising:
receiving resource utilization status information from the CS; and
determining whether to release a resource of the CS based on the resource utilization status information.

4. The resource allocation method of claim 3, wherein the resource utilization status information includes:
a start timestamp indicating a start time of a check of a resource utilization status of the CS;
an end timestamp indicating an end time of the check of the resource utilization status of the CS;
a storage usage of the CS;
an upload traffic of the CS;
a download traffic of the CS;
an uplink bandwidth of the CS;
a downlink bandwidth of the CS;
a number of peer connections used for the CS to upload traffic; and
a number of peer connections used for the CS to download traffic.

5. The resource allocation method of claim 1, further comprising:
transmitting a request message to the another CS to reserve a resource of the another CS; and
receiving a response message from the another CS.

6. The resource allocation method of claim 5, wherein the response message includes an identifier of the resource to be reserved, an identifier of a virtual peer of the another CS, or a maximum allocation time of the resource.

7. The resource allocation method of claim 1, wherein the CS is configured to verify whether the peer is included in the remote peer list in response to the remote peer list being received, and add the peer to the peer list to be transmitted to the OMS in response to the peer being included in the remote peer list.

8. An overlay management server (OMS) comprising:
a communication interface; and
a controller configured to transmit, to a cache server (CS) through the communication interface, a remote peer list determined based on a network distance between each of peers in an overlay network and the CS, receive a peer list including an identifier of a peer interacting with the CS from the CS through the communication interface in response to the remote peer list being transmitted, and select another CS to be added to the overlay network using the peer list.

9. The OMS of claim 8, wherein the controller is configured to obtain a CS list determined based on a network distance between each of CSs and the peer, and select the another CS among the CSs based on the CS list.

10. The OMS of claim 8, wherein the controller is configured to receive resource utilization status information from the CS through the communication interface, and determine whether to release a resource of the CS based on the resource utilization status information.

11. The OMS of claim 10, wherein the resource utilization status information includes:
a start timestamp indicating a start time of a check of a resource utilization status of the CS;
an end timestamp indicating an end time of the check of the resource utilization status of the CS;
a storage usage of the CS;
an upload traffic of the CS;
a download traffic of the CS;
an uplink bandwidth of the CS;
a downlink bandwidth of the CS;
a number of peer connections used for the CS to upload traffic; and
a number of peer connections used for the CS to download traffic.

12. The OMS of claim 8, wherein the controller is configured to transmit a request message to the another CS through the communication interface to reserve a resource of the another CS, and receive a response message from the another CS through the communication interface.

13. The OMS of claim 12, wherein the response message includes at least one of an identifier of the resource to be reserved, an identifier of a virtual peer of the another CS, or a maximum allocation time of the resource.

14. The OMS of claim 8, wherein the CS is configured to verify whether the peer is included in the remote peer list in response to the remote peer list being received, and add the peer to the peer list to be transmitted to the OMS in response to the peer being included in the remote peer list.

15. A managed peer-to-peer (MP2P) network system, comprising:
a cache server (CS); and
an overlay management server (OMS) configured to transmit, to the CS, a remote peer list determined based on a network distance between each of peers and the CS, receive a peer list including an identifier of a peer receiving contents from the CS in response to the peer being included in the remote peer list, and select another CS for the peer in response to the peer list being received.

16. The MP2P network system of claim 15, wherein the OMS is configured to receive a CS list determined based on a network distance between each of CSs and the peer, and select the another CS among the CSs based on the CS list.

17. The MP2P network system of claim 15, wherein the OMS is configured to receive resource utilization status information from the CS, and determine whether to release a resource of the CS based on the resource utilization status information.

18. The MP2P network system of claim 17, wherein the resource utilization status information includes:
a start timestamp indicating a start time of a check of a resource utilization status of the CS;
an end timestamp indicating an end time of the check of the resource utilization status of the CS;
a storage usage of the CS;
an upload traffic of the CS;
a download traffic of the CS;
an uplink bandwidth of the CS;
a downlink bandwidth of the CS;
a number of peer connections used for the CS to upload traffic; and
a number of peer connections used for the CS to download traffic.
